(19) United States
(12) Patent Application Publication
(10) Pub. No.: US 2014/0110471 A1
(43) Pub. Date: Apr. 24, 2014

(54) SENSORS AND METHOD FOR VERIFICATION OF AGENTS - POWDER, LIQUID, GASEOUS OR OTHER AGENTS - IN A VESSEL

(71) Applicants: Suminto D. Filip To, Starkville, MS (US); Pamela Sue Bridges, Laurel, MS (US)

(72) Inventors: Suminto D. Filip To, Starkville, MS (US); Pamela Sue Bridges, Laurel, MS (US)

(21) Appl. No.: 14/061,690

(22) Filed: Oct. 23, 2013

Related U.S. Application Data
(60) Provisional application No. 61/717,601, filed on Oct. 23, 2012.

(51) Int. Cl. G01N 35/00

(52) U.S. Cl. CPC G01N 35/00
USPC 235/375; 73/865.8

(57) ABSTRACT

Agent verification can be performed by initially embedding definitive identification and parametric information regarding the vessel into a sensor set. The integrated sensor set, with a communication means, is incorporated into the vessel and/or its integral components to detect the current state of the vessel and its content. The information and sensor set can be normally passive or normally dormant, and can be activated by means of an external stimulus. Positive determination of the integrity of the vessel and its content is accomplished by interrogating the sensor set for detecting the current parameters and comparing the status of the vessel and its content against the initially embedded information using an external instrument. A match signifies a validation and the absent of a match signifies a non-valid condition. The method of providing indication of a valid or a non-valid condition can be accomplished by any means available, electronically or otherwise.

### CROSS-REFERENCE TO RELATED APPLICATION

This application claims the benefit of priority of U.S. provisional application No. 61/717,601, filed Oct. 23, 2012, the contents of which are herein incorporated by reference.

### BACKGROUND OF THE INVENTION

The present invention relates to sensors and sensing methods and more particularly, to sensors and methods for verification of agents, such as powders, liquids, gases, or other agents, in a vessel.

Current methods of detecting and verifying the content of a vessel involve imaging techniques, such as x-ray or taking a sample from the vessel. These methods are often expensive, time consuming or require specialized knowledge or expertise. When the vessel is a pressurized vessel, many systems require depressurizing the vessel first, before authenticating or validating the content.

As can be seen, there is a need for an improved device and method for verification of agents in a vessel.

### SUMMARY OF THE INVENTION

In one aspect of the present invention, a method for validation of agents in a vessel comprises embedding physical characteristics and definitive information related to the vessel, at a time of manufacture, into a lockable electronic memory portion of an embedded device; and interrogating a filled vessel upon deployment by software on a portable device via a communication link to verify the physical characteristics and information, wherein a match of information constitutes a validation.

In another aspect of the present invention, a method for validation of agents in a vessel comprises embedding physical characteristics and definitive information related to the vessel, at a time of manufacture, into a lockable electronic memory portion of an embedded device; embedding updateable information into an updateable electronic memory portion of the embedded device; and interrogating a filled vessel upon deployment by software on a portable device via a communication link to verify the physical characteristics and information, wherein a match of information constitutes a validation, wherein the embedded device is normally passive and is activated upon interrogation; and the embedded device includes a sensor attached to a threaded plug housing, the threaded plug housing removable disposed in the vessel.

In a further aspect of the present invention, a sensor set comprises a lockable electronic memory portion having embedded physical characteristics and definitive information related to a vessel, at a time of manufacture; a sensor for detecting contents of the vessel; and a communication link for communicating with a portable device having software for receiving data from the sensor, the software being able to verify the physical characteristics and information from the sensor.

These and other features, aspects and advantages of the present invention will become better understood with reference to the following drawings, description and claims.

### BRIEF DESCRIPTION OF THE DRAWINGS

FIG. 1 is a perspective view of a vessel having a sensor disposed therein according to an exemplary embodiment of the present invention;

FIG. 2 is a perspective view of the sensor of FIG. 1, removed from the vessel;

FIG. 3 is a front view of the sensor of FIG. 1, removed from the vessel;

FIG. 4 is a side view of the sensor of FIG. 1, removed from the vessel;

FIG. 5 is a top view of the sensor of FIG. 1, removed from the vessel;

FIG. 6 is a cross-sectional view taken along line 6-6 of FIG. 1; and

FIG. 7 is a schematic representation of firmware architecture used with the sensor of FIG. 1, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides methods and apparatus that solve the problem of agent verification by initially embedding definitive identification and parametric information regarding the vessel, and the intended agent it contains, into a sensor set disposed in the vessel or as an integral component of the vessel. The integrated sensor set with a communication means is incorporated into the vessel and/or its integral components to detect the current state of the vessel and its content. The information and sensor set can be normally passive or normally dormant, and can be activated by means of an external stimulus. Positive determination of the integrity of a vessel and its content is accomplished by interrogating the sensor set for detecting the current parameters and comparing the status of the vessel and its content against the initially embedded information using an external instrument. A match signifies a validation and the absent of a match signifies a non-valid condition. The method of providing indication of a valid or a non-valid condition can be accomplished by any means available electronically or otherwise.

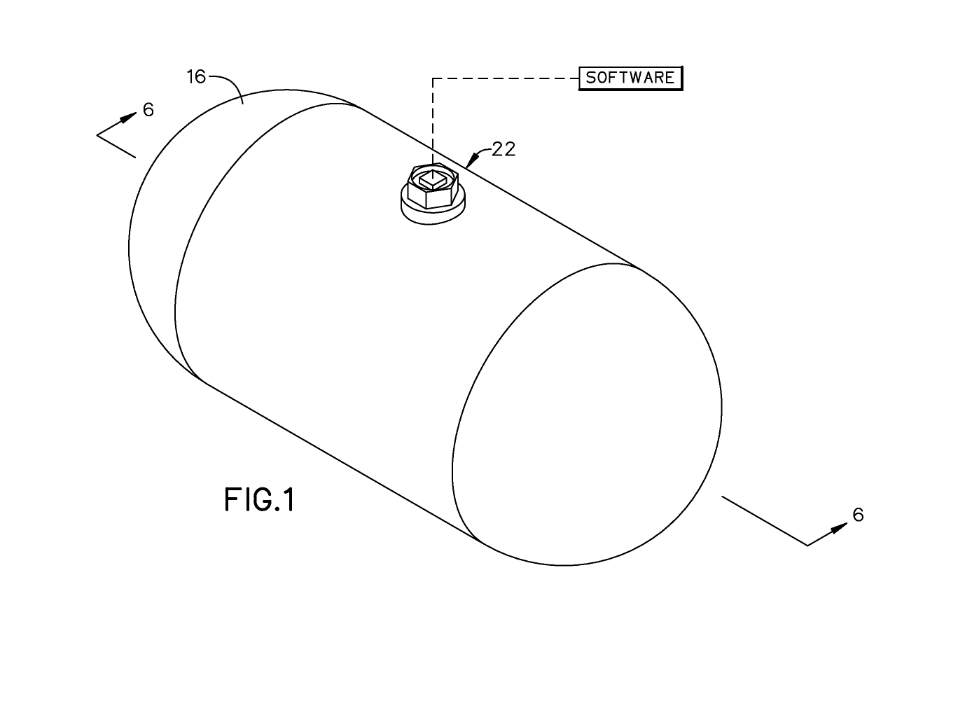

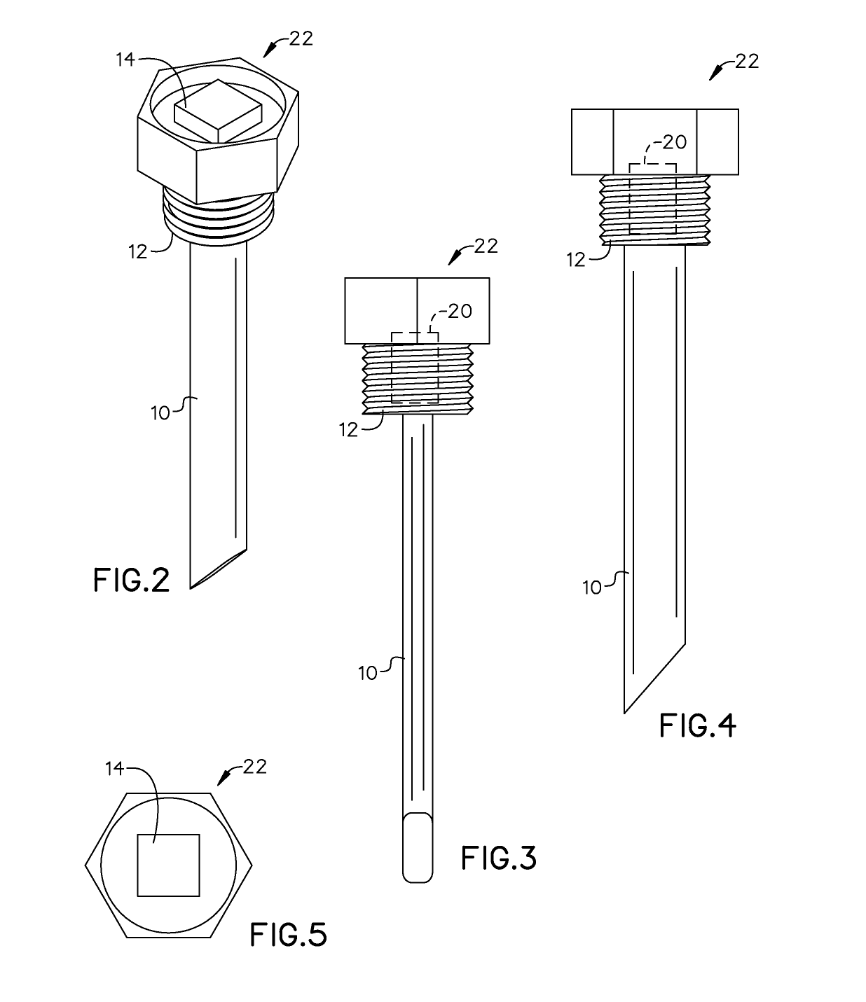

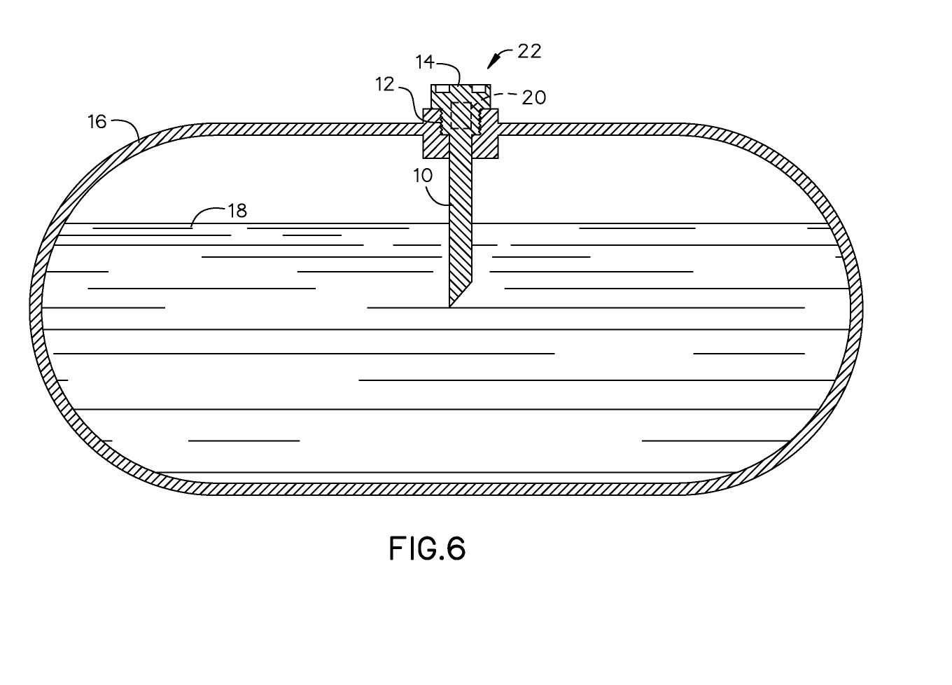

Referring now to FIGS. 1 through 6, with respect to hardware, the present invention incorporates a method of embedding lockable and updateable information, and sensors 10 into electronic hardware. The electronic hardware can include, for example, electronic computer memory for storing information. The sensor 10 can be embedded into a vessel 16 or can be designed to attach to the vessel 16. For example, the sensor 10 can be attached to a threaded plug 12 that attaches to the vessel 16, allowing the sensor 10 to be disposed inside the vessel 16. While FIG. 1 shows a particular size, shape and configuration of the sensor set 22 inside the vessel 16, it should be understood that the sensor set 22 can be positioned at any location of the vessel 16 and the vessel 16 can take on various sizes and shapes.

The lockable information includes the identity and the original parameters of the vessel 16 and its content 18, and the updateable information will be other information such as geo-location of the vessel 16, maintenance records and sensors readings, for example. The electronic hardware 20 can be encapsulated into a tube, an enclosure, or an can be integral part of the vessel.

Information can be communicated thru an embedded communication link 14 between an interrogating device (like a handheld computer, not shown) and the hardware 20. Additional geo-location and wireless triggering hardware can be embedded into the system to enable tracking for finding lost vessels. The communication link 14 can also be a means to supply power to the hardware. The communication link 14 can be in the form of wire, or wireless. One exemplary embodiment of this communication link 14 is by a four-wire link with a four contact connector as the terminator and information exchange occurs serially.

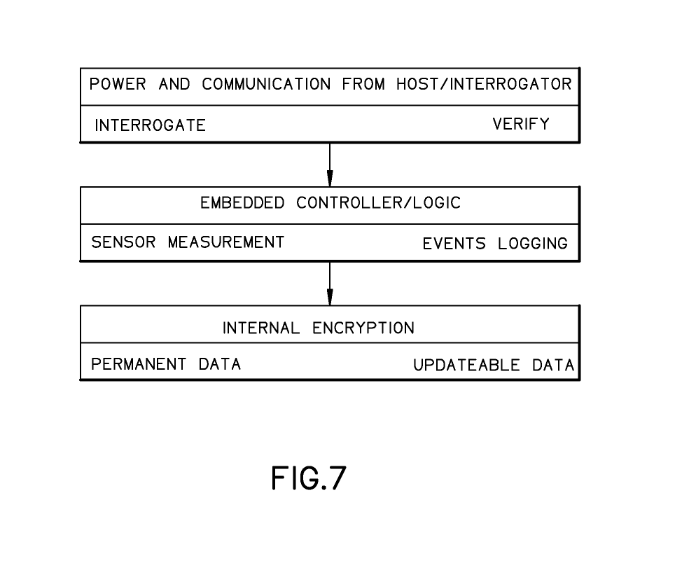

With respect to firmware, referring now also to FIG. 7, the present invention incorporates firmware for secure and proper usage of the information.

The firmware incorporates the necessary protocols for communication and for access to the information embedded in the hardware. Bypassing of the firmware can only be done by destructive means. The firmware can interrogate the sensor set 22, verify data, log events, process sensor measurements, and the like. An external device can be used for communicating with the embedded device. This external device (not shown) requires a specific logic (software and hardware) of a specific purpose. The same external device can be used to find and locate missing vessels by triggering the geo-location hardware disposed in the sensor set 22 wirelessly.

Elements that are used in the present invention include the embedded hardware, sensors, firmware as described above, the software, firmware, and the identification information/original factory standards or intent of the contents of the vessel.

Sensors for detecting chemical agents, or other similar liquids, gases, solids, or the like, inside the vessel are embedded into the integral part of the vessel such as a syphon tube or a plug (also referred to as sensor 10), the electronics 20 associated with the storage of data/information and logic for communication are embedded likewise. The embedding of wire and electronics is in such a way that it does not interfere with other functions of the vessel such as flow characteristics. Low voltage operation can be incorporated to eliminate the possibility of spark generation or other electrically related hazards. A portable interrogating device (including a handheld/portable computer) with specific software (generically shown as software in FIG. 1) can be used to activate and to communicate between the user and the system, and a decision making feature is incorporated into the software to aid the user in the process of identification and validation of the vessel and its content. The method described in this invention facilitates a “cradle to grave” tracking of a vessel and immediate verification of its content. The embedded data is useful for forensic back tracing in the event that the need arises.

The method of search-and-locate is for determining the geo-location of the vessel. The handheld interrogating device is used to “read” the geo-location of a vessel wirelessly by activating its geo-locating hardware wirelessly. The same method is used to locate a missing vessel by activating the geo-location and wireless communication means.

The physical characteristics and information related to the vessel at the time of manufacture are embedded into the lockable portion of the embedded device. The information includes, but is not limited to, manufacturer code, date, material, electrical impedance, weight, capacity, and code designating the intended use and the designated agent. This initial data constitute a “birth certificate” of a vessel. Upon deployment, the filled vessel can be interrogated by a portable (handheld) device, such as a tablet computer, laptop computer, smartphone, or other such portable electronic device, via the provided communication link to verify the exteriorly affixed labels (barcode of RFID), the birth certificate and other data, that were provided at the time of manufacture, and the current agent inside the vessel. A match of information embedded in the birth certificate and the currently detected information constitutes a validation, and a no-match constitutes a fail-to-validate condition. The portable interrogation/inspection device contains the logic/software for recording and transmission of data to an external data repository system where further processing can be performed. Other capabilities incorporated into the portable inspection device include other documentation means such as photograph and other forms of note taking.

The process includes the use of embedded microcomputer/logic. The present invention can be used to track everything that goes on with fire extinguishers or other pressure vessels from the time they are manufactured to the time of their disposal, including its geo-locations. The present invention can be used to implement a safety protocol with a high degree of confidence and a high level of security.

The present invention can be used in any industry where pressure vessels or other storage vessels or cylinders that are in transport or storage or in use that require verification of the contents inside the vessels, and to determine if it has been compromised.

An embodiment of the invention can be in the form of a Smart Tube or a Plug, as shown in the Figure, or an integral part of a vessel, or an insert component of a system.

It should be understood, of course, that the foregoing relates to exemplary embodiments of the invention and that modifications may be made without departing from the spirit and scope of the invention as set forth in the following claims.

What is claimed is:

1. A method for validation of agents in a vessel comprising:
embedding physical characteristics and definitive information related to the vessel, at a time of manufacture, into a lockable electronic memory portion of an embedded device; and
interrogating a filled vessel upon deployment by software on a portable device via a communication link to verify the physical characteristics and information, wherein a match of information constitutes a validation.

2. The method of claim 1, further comprising embedding updateable information into an updateable electronic memory portion of the embedded device.

3. The method of claim 1, wherein the physical characteristics and definitive information related to the vessel includes manufacturer code, date, material, electrical impedance, weight, capacity, and an intended use code and a designated agent code.

4. The method of claim 2, wherein the updateable information includes geo-location of the vessel, maintenance records and sensors readings.

5. The method of claim 1, wherein the embedded device is normally passive and is activated upon interrogation.

6. The method of claim 1, wherein the embedded device includes a sensor attached to a threaded plug housing, the threaded plug housing removable disposed in the vessel.

7. A method for validation of agents in a vessel comprising:
embedding physical characteristics and definitive information related to the vessel, at a time of manufacture, into a lockable electronic memory portion of an embedded device;
embedding updateable information into an updateable electronic memory portion of the embedded device; and
interrogating a filled vessel upon deployment by software on a portable device via a communication link to verify the physical characteristics and information, wherein a match of information constitutes a validation, wherein the embedded device is normally passive and is activated upon interrogation; and
the embedded device includes a sensor attached to a threaded plug housing, the threaded plug housing removable disposed in the vessel.

8. The method of claim 7, wherein:
the physical characteristics and definitive information related to the vessel includes manufacturer code, date, material, electrical impedance, weight, capacity, and an intended use code and a designated agent code; and
the updateable information includes geo-location of the vessel, maintenance records and sensors readings.

9. A sensor set comprising:
a lockable electronic memory portion having embedded physical characteristics and definitive information related to a vessel, at a time of manufacture;
a sensor for detecting contents of the vessel; and
a communication link for communicating with a portable device having software for receiving data from the sensor, the software being able to verify the physical characteristics and information from the sensor.

10. The sensor set of claim 9, further comprising an updateable electronic memory portion for embedding updateable information therein.
